(19) United States
(12) Patent Application Publication
(10) Pub. No.: US 2002/0032747 A1
(43) Pub. Date: Mar. 14, 2002

(54) System, method, device, and program for distributing data, and data reproduction device

(75) Inventor: Nozomi Toki, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/949,831

(22) Filed: Sep. 12, 2001

(30) Foreign Application Priority Data
Sep. 11, 2000 (JP) 280151/2000

(51) Int. Cl. G06F 15/16

(52) U.S. Cl. 709/217; 709/229

(57) ABSTRACT

A server stores media data excluding a data portion which is the same as sample data being a part of the media data, as distribution data to be distributed. A reproduction terminal stores the sample data. The reproduction terminal downloads predetermined distribution data from the server through a network, in accordance with the operation of a user. The reproduction terminal generates the media data from the sample data which is provided in advance and the downloaded distribution data, thereby reproducing the media data. The reproduction terminal reproduces the generated media data.

### BACKGROUND OF THE INVENTION

1. Field of the Invention

The present invention relates to a system, method, device and program for distributing data.

2. Description of the Related Art

When purchasing music data, in many cases, consumers listen to a sample of a particular song or music, and determine whether to purchase the music data based on the sample music.

A technique for providing sample music and selling music data (music software) is disclosed in Unexamined Japanese Patent Application KOKAI Publication H10-302150. A terminal for selling the music data which is disclosed in the above publication downloads sample data of user-selected music software from a predetermined server. Users then listen to the downloaded sample music, and check the contents of the target music software. If the users determine to purchase the target music software, the terminal executes a payment process, thereafter outputting predetermined music software which is contained inside the terminal in advance.

According to the technique disclosed in Unexamined Japanese Patent Application KOKAI Publication No. H10-302150, the users need to go to the terminal to purchase the music software. Depending on the sales amount of the music software, the music software may frequently be added into the terminal. In such circumstances, if there are a large number of terminals, it is quite troublesome to maintain the music software in each of the terminals.

The above problem can be solved by directly supplying the sample data and music data to the terminals possessed by the users, through a communications network.

A technique for supplying the music data through a communications network is disclosed in Unexamined Japanese Patent Application KOKAI Publication No. 2000-99010. A user terminal disclosed in this publication downloads predetermined music data from a predetermined server through a communications network, after the payment is made.

The music data to be supplied using the technique of Unexamined Japanese Patent Application KOKAI Publication No. 2000-99010 is in a complete form. As explained above, in the case where the sample data is downloaded from the server before purchasing music data, it is not efficient that the music data in a complete form is downloaded. Usually, the sample data is a part of the music data. In other words, the music data to be downloaded includes a data portion(s) which is the same as the sample data. Therefore, it take extra time to download the complete form of music data, by a period for downloading the same portion of the music data.

As disclosed in Unexamined Japanese Patent Application KOKAI Publication No. 2000-99010, if the payment is done before the downloading of the music data, the music data may not efficiently be distributed. For example, in the case where the downloading of the music data is not appropriately completed as a result of a some kind of communications trouble, the users may have to cancel the formerly-completed payment process or may have to again go through the procedures for the payment. Accordingly, the distribution of the music data may not efficiently be performed.

The entire disclosures of Unexamined Japanese Patent Application KOKAI Publication Nos. H10-302150 and 2000-99010 are herein incorporated in the entirety.

### SUMMARY OF THE INVENTION

It is accordingly an object of the present invention to provide a system, method, device and program for efficiently realizing data distribution in a short period of time.

In order to attain the above object, according to the first aspect of the present invention, there is provided a data distribution system, comprising:

a server which stores, as distribution data to be distributed, media data excluding a data portion which is same as sample data being a part of the media data; and

at least one reproduction terminal which reproduces the media data, and

wherein the reproduction terminal includes

a memory which stores the sample data,

a downloader which downloads predetermined distribution data from the server, and

a player which reproduces the sample data stored in the memory and the distribution data downloaded by the downloader.

According to this invention, the data distribution can be achieved in a short period of time with high efficiently.

The player may include a data generator which generates the media data from predetermined sample data stored in the memory and the distribution data downloaded by the downloader.

The data generator may:

divide the distribution data into a part corresponding to a data portion preceding the sample data in the media data and a part corresponding to a data portion following the sample data in the media data; and

arrange the divided distribution data and sample data in time series, thereby generating the media data.

The data generator may encode the generated media data using a predetermined encoding method; and

the player may decode the encodes media data using a predetermined decoding method, and reproduce the decodes media data.

The data generator may attach a header including information regarding the predetermined encoding method for encoding the media data, to the encoded media data; and

the player may decode the encoded media data, based on the information included in the header.

The server may include a supplier which supplies the at least one reproduction terminal having downloaded the distribution data with a media key representing information for dividing the distribution data, and

the data generator may divide the distribution data using the supplied media key.

The data generator may determine whether the media key supplied from the server is a proper key, and generate the media data using the media key, in a case where it is determined that the media key is a proper media key.

The data generator may delete the media key, in a case where the media data is completely generated.

The server may include a charger which charges, in a case where the at least one reproduction terminal completely downloads the distribution data, a user operating the at least one terminal for the distribution data.

In order to attain the above object, according to the second aspect of the present invention, there is provided a data distribution method comprising:

storing, as distribution data to be distributed, media data excluding a data portion which is same as sample data being a part of the media data, in a server;

storing the sample data being the part of the media data in at least one terminal;

downloading predetermined distribution data from the server into the at least one terminal through a communications network; and

reproducing the stored sample data and the downloaded distribution data in the at least one terminal.

The reproducing may include generating, in the at least one terminal, the media data from the stored sample data and downloaded distribution data.

The generating may include:

dividing the distribution data into a part corresponding to a data portion preceding the sample data in the media data and a part corresponding to a data portion following the sample data in the media data; and

arranging the divided distribution data and the sample data in time series, thereby generating the media data.

The data distribution method may further include

supplying, from the server, the division information for dividing the distribution data to the at least one terminal having downloaded the distribution data, and

wherein the dividing includes dividing the distribution data using the division information.

The generating may include encoding the generated media data using a predetermined encoding method; and

the reproducing may include decoding the encoded media data using a predetermined decoding method and reproducing the decoded media data.

The encoding may include attaching a header including information regarding the encoding method for encoding the media data, to the encoded media data; and

the reproducing may include decoding the encoded media data, based on the information included in the header.

The data distribution method may further include

charging, in a case where the at least one terminal has completely downloaded the distribution data, a user operating the at least one terminal for the downloaded distribution data, in the server.

The generating may include determining whether the media key is a proper media key; and

the dividing may include dividing the distribution data using the media key in a case where it is determined that the media key is a proper media key.

The generating may include deleting the media key, in a case where the media data is completely generated.

In order to attain the above object, according to the third aspect of the present invention, there is provided a data distribution device, comprising:

a memory which stores, as distribution data to be distributed, media data excluding a data portion which is same as sample data being a part of the media data; and

a data supplier which supplies at least one terminal with predetermined distribution data stored in the memory through a communications network, in response to a request from the at least one terminal storing the sample data.

The data distribution device may further include a charger which charges, in response to a completion signal being sent from the at least one terminal and representing that the distribution data is completely received, a user operating the at least one terminal, for the supplied distribution data.

The data distribution device may further include an information supplier which supplies division information for dividing the distribution data into a part corresponding to a data portion preceding the sample data in the media data and a part corresponding to a data portion following the sample data in the media data, to the at least one terminal having received the distribution data.

In order to attain the above object, according to the fourth aspect of the present invention, there is provided a data reproduction device comprising:

a memory which stores sample data being a part of media data;

a downloader which downloads distribution data to be distributed from a server storing, as the distribution data, the media data excluding a data portion which is same as the sample data, through a communications network; and

a player which reproduces the sample data stored in the memory and the distribution data downloaded by the downloader.

The player may include a data generator which generates the media data from predetermined sample data stored in the memory and the distribution data downloaded by the downloader.

The data generator may:

divide the distribution data into a part corresponding to a data portion preceding the sample data in the media data and a part corresponding to a data portion following the sample data in the media data; and

arrange the divided distribution data and sample data in time series, thereby generating the media data.

The data generator may encode the generated media data using a predetermined encoding method; and

the player may decode the encoded media data using a predetermined decoding method and reproduces the decoded media data.

The data generator may attach a header including information representing the encoding method for encoding the media data, to the encoded media data; and

the player may decode the encoded media data, based on the information included in the header.

The data generator may divide the distribution data, using a media key supplied from the server and representing information for dividing the distribution data, and delete the media key in a case where the media data is completely generated.

The data generator may determine whether the media key supplied from the server is a proper media key, and generate the media data using the media key, in a case where it is determined that the media key is a proper media key.

In order to attain the above object, according to the fifth aspect of the present invention, there is provided a program for controlling a computer to function as a data distribution device comprising:

a memory which stores, as distribution data to be distributed, media data excluding a data portion which is same as sample data being a part of the media data; and

a supplier which supplies, in response to a request from a predetermined terminal connected to the computer through a communications network, the terminal with predetermined distribution data stored in the memory.

In order to attain the above object, according to the sixth aspect of the present invention, there is provided a program for controlling a computer to function as a data distribution device comprising:

a memory which stores sample data being a part of media data;

a downloader which downloads predetermined distribution data to be distributed from a server storing, as the distribution data, the media data excluding a data portion which is same as the sample data being a part of the media data; and

a player which reproduces the sample data stored in the memory and the distribution data downloaded by the downloader.

### BRIEF DESCRIPTION OF THE DRAWINGS

The object and other objects and advantages of the present invention will become more apparent upon reading of the following detailed description and the accompanying drawings in which:

FIG. 1 is a diagram showing the structure of a data distribution system according to an embodiment of the present invention;

FIG. 2 is a diagram showing the structure of a data server in the data distribution system of FIG. 1;

FIGS. 3A and 3B are diagrams each showing information stored in a database of the data server shown in FIG. 2;

FIG. 4 is a diagram showing the relationship between sample data and download data (DL) data;

FIG. 5 is a diagram showing the structure of a user terminal included in the data distribution system of FIG. 1;

FIG. 6A is a flowchart showing a download process carried out by a controller in the user terminal, and

FIG. 6B is a flowchart showing a data supply process carried out by a controller in the data server;

FIGS. 7A and 7B are diagrams each showing a sample header attached to sample data, and

FIGS. 7C and 7D are diagrams each showing a data header attached to DL data;

FIG. 8 is a flowchart showing a data generation process carried out by the controller of the user terminal;

FIG. 9 is a diagram showing data which is shown in time series; and

FIGS. 10A and 10B are diagrams each showing the structure of a reproduction data header attached to reproduction data to be reproduced.

### DETAILED DESCRIPTION OF THE PREFERRED EMBODIMENT

A data distribution system and a data distribution method according to an embodiment of the present invention will now be explained with reference to the accompanying drawings.

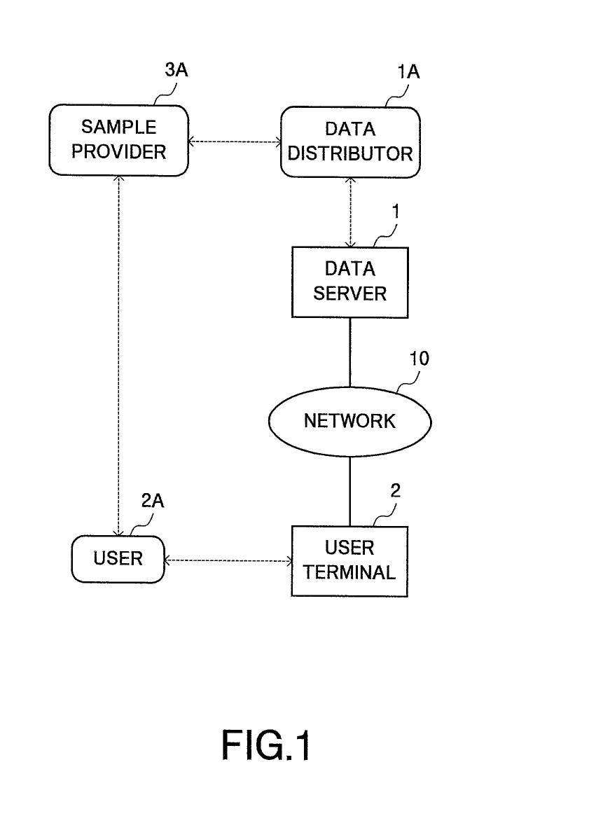

The data distribution system according to the embodiment of the present invention comprises a data server 1 and a user terminal 2 which are connected with each other through a network 10, such as the Internet, etc., as shown in FIG. 1.

The data server 1 is managed by a data distributor 1A. A data portion of media data (music data, video data, etc.) which is supplied by the data distributor 1A is sent in the form of sample data, to a user 2A (or the user terminal 2) through a sample provider 3A. The data server 1 stores, as download data (DL data), the remaining portions of media data excluding the sample data portion. The data server 1 supplies the user terminal 2 with predetermined DL data, in response to a request from the user terminal 2. The data server 1 supplies the user terminal 2 having downloaded the DL data with a media key necessary for generating media data from the sample data and DL data. The structure of the data server 1 will be described in more detail later.

The user terminal 2 includes desktop-type computer, a notebook computer, or a mobile communications terminal (e.g. cellular phone, etc.) which can access the data server 1 through the network 10. The user terminal 2 downloads predetermined DL data from the data server 1, in accordance with the operations of the user 2A.

Sample data, a data generation program, and a player (a reproduction program) are installed by the user 2A in the user terminal 2. The data generation program is for generating media data from the sample data and DL data, using the media key supplied from the data server 1. The data generation program generates data to be reproduced, by encrypting and/or compressing the media data using a predetermined technique. The player decodes or uncompresses reproduction data (to be reproduced) generated by the data generation program using a predetermined technique, and reproduces the data.

The structure of the user terminal 2 will specifically be explained later.

The structure of the data server 1 will now be described.

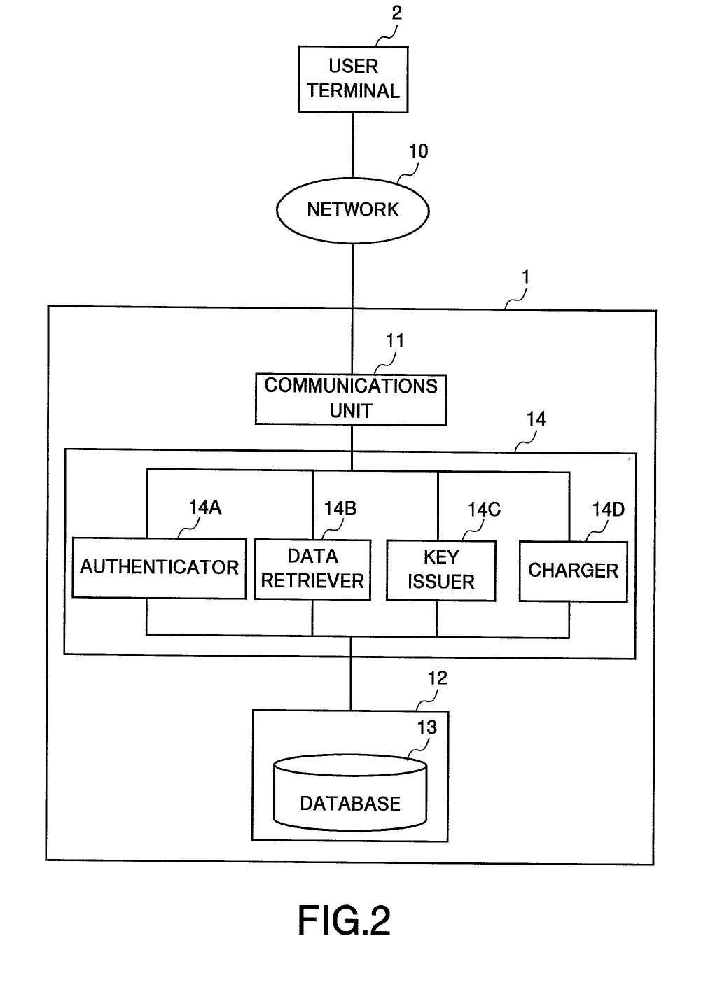

The data server 1 comprises a communications unit 11, a memory unit 12, a database 13, and a controller 14, as shown in FIG. 2.

The communications unit 11 is connected to the network 10, and performs data communications with the user terminal 2.

The memory unit 12 includes a RAM (Random Access Memory) and ROM (Read Only Memory), etc. The memory unit 12 stores programs and data, etc. for controlling the data server 1. The memory unit 12 has a database 13 which stores user information, DL data, media information, etc.

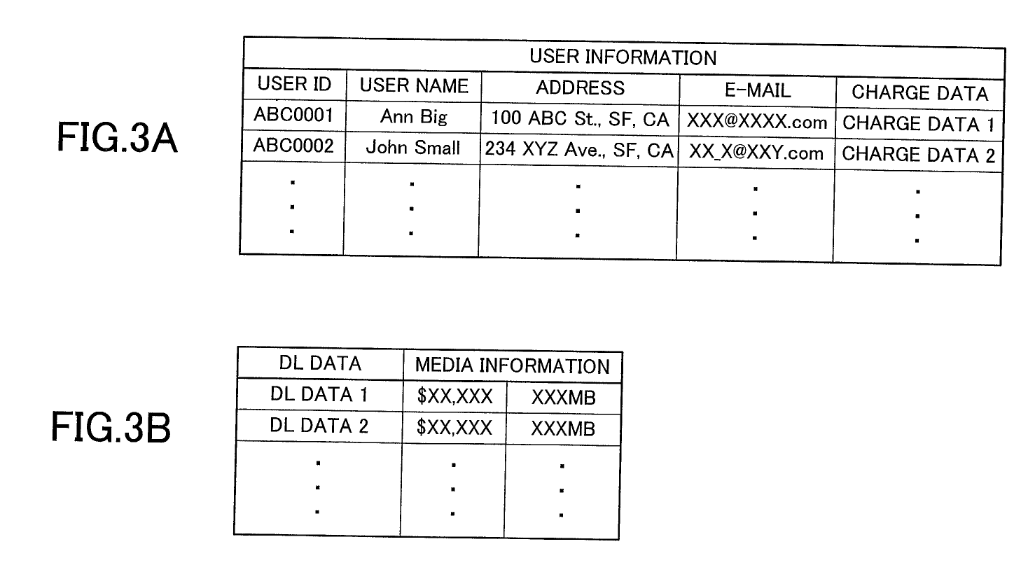

The user information represents information regarding each user 2A registered in the data server 1. Particularly, the user information includes, as shown in FIG. 3A, user IDs, user names, user addresses, e-mail addresses, and charge data, in association with one another. The charge data indicates the amount of money charged to the user 2A who has downloaded the DL data.

The DL data and media information are stored in the database 13 in association with each other, as illustrated in FIG. 3B. The media information represents the price of correpsonding DL data and its data amount.

The controller 14 includes a CPU (Central Processing Unit), etc. The controller 14 operates in accordance with the programs and data stored in the memory unit 12. The controller 14 serves as any of an authenticator 14A, a data retriever 14B, a key issuer 14C, and a charger 14D, etc., as needed.

The controller 14 serving as the authenticator 14A authenticates (verifies) the user 2A, based on the user ID sent from the user terminal 2 and the user information stored in the database 13.

The controller 14 serving as the data retriever 14B retrieves the DL data, selected by the user 2A, from the database 13, in response to a request from the user terminal 2, and sends it to the user terminal 2 through the communications unit 11.

The controller 14 serving as the key issuer 14C issues a media key for use in generating media data, and gives the issued media key to the user terminal 2 having completely downloaded the DL data.

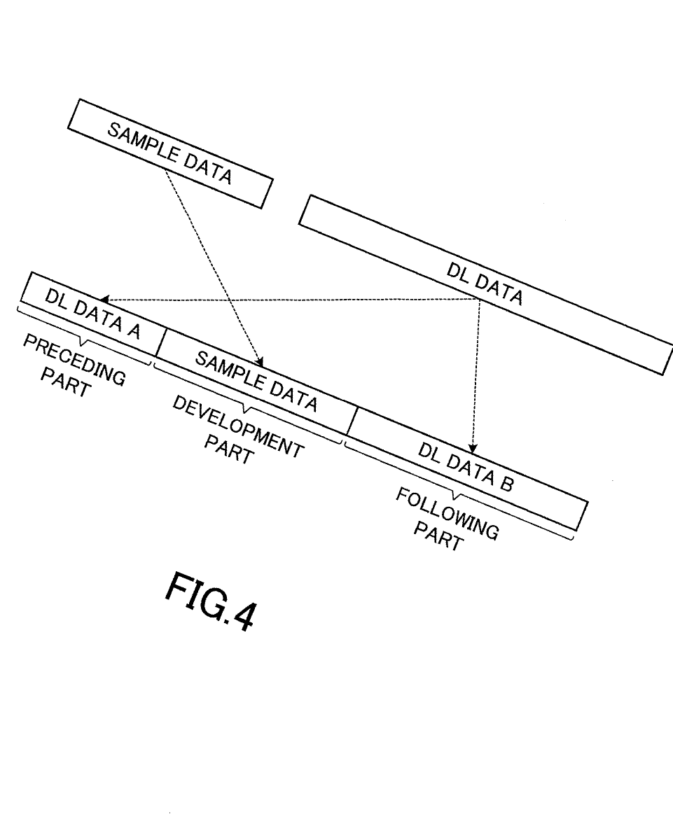

As described above, the sample data and DL data are the portions of the media data, respectively. For example, if the sample data corresponds to a development part of a song, the DL data is composed of DL data A corresponding to the part before (preceding) the development part of the song and DL data B corresponding to the part after (following) the development part of the song, as shown in FIG. 4. Hence, to generate media data, the DL data needs to be divided into the DL data A and DL data B. The media key includes information for desirably dividing the DL data into the DL data A and DL data B.

The controller 14 serving as the charger 14D updates the charge data of the user 2A having downloaded the DL data. Upon this, the controller 14 serving as the charger 14D charges the user 2A, having downloaded the DL data, the amount of money for the DL data.

The structure of the user terminal 2 will now specifically be explained.

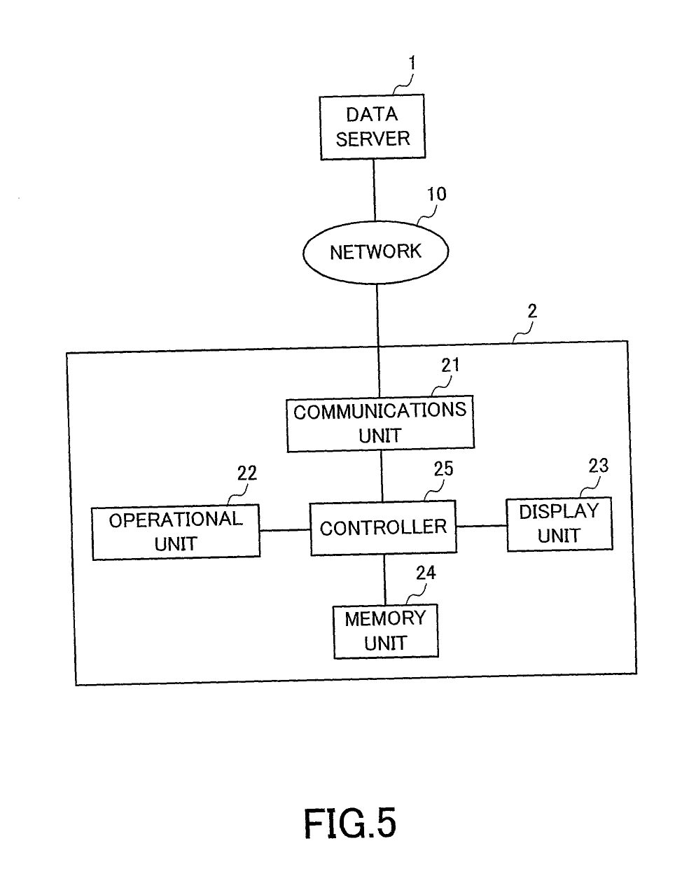

As illustrated in FIG. 5, the user terminal 2 comprises a communications unit 21, an operational unit 22, a display unit 23, a memory unit 24, and a controller 25.

The communications unit 21 is connected to the network 10, and performs data communications with the data server 1.

The operational unit 22 includes a plurality of operational keys, and operated by the user 2A. The operational unit 22 outputs various signal for controlling the user terminal 2 to the controller 25, in accordance with the operation of the user 2A.

The display unit 23 includes an LCD (Liquid Crystal Display), etc., and displays predetermined character strings, design, and the like, so as to provide information indicating the operational contexts of the user terminal 2. The display unit 23 displays also reproduced media data (e.g. video data, or the like).

The memory unit 24 includes a RAM, ROM, etc. The memory unit 24 stores programs, data, and the like for operating the user terminal 2. For example, the memory unit 24 stores a user ID, sample data, data generation program, and player (reproduction program), etc.

The controller 25 includes a CPU, and controls operations of the user terminal 2, in accordance with the programs and data stored in the memory unit 24.

The data distribution method to be carried out by the above-described data distribution system will now be explained.

The user 2A goes through registration procedures, and obtains a user ID from the data distributor 1A. Thus obtained user ID is stored as user information in the database 13 of the data server 1, together with the user 2A's name, address, and any other necessary information. Then, the user 2A is registered in the data server 1. The user ID is stored in the memory unit 24 of the user terminal 2.

The user 2A operates the operational unit 22, to install the player (reproduction program) supplied by the data distributor 1A in the user terminal 2 through the network 10.

The user 2A operates the operational unit 22, to install the sample data and data generation program supplied by the sample provider 3A in the user terminal 2 through the network 10.

The user 2A operates the operational unit 22, to reproduce the sample data, and selects certain sample data which the user 2A likes.

The user 2A operates the operational unit 22, to download, from the data server 1, the DL data extracted from the same media data as the selected sample data, i.e. the DL data forming a pair with the selected sample data.

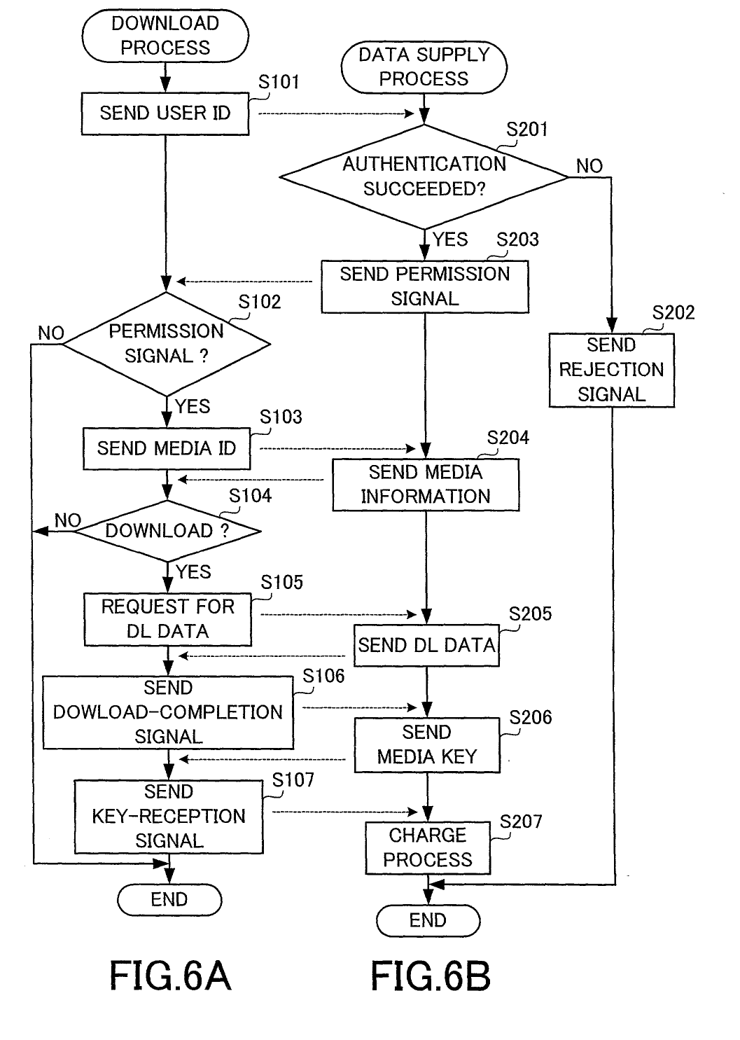

Specifically, in response to a predetermined signal sent from the operational unit 22 by the operation of the user 2A, the controller 25 of the user terminal 2 carries out a download process shown in FIG. 6A, in accordance with the programs and data stored in the memory unit 24.

The controller 25 sends the user ID stored in the memory unit 24 to the data server 1 through the network 10 (Step S101).

In response to the sent user ID from the user terminal 2, the controller 14 of the data server 1 begins to execute a data supply process shown in FIG. 6B, in accordance with the programs and data, etc., stored in the memory unit 12.

In response to the sent user ID from the user terminal 2, the controller 14 carries out the procedure for authenticating the user 2A. In more particular, the controller 14 retrieves user information from the database 13, and determines whether the supplied user ID exists in there (Step S201).

In the case where it is determined that the supplied user ID is not stored in the database 13, i.e. in the case where the user authentication is not succeeded (Step S201; NO), the controller 14 sends a rejection signal for rejecting the downloading of the DL data to the user terminal 2 (Step S202), and the data supply process is terminated.

On the contrary, in the case where it is determined that the user ID is stored in the database 13, i.e. in the case where the user authentication is succeeded (Step S201; YES), the controller 14 sends a permission signal for permitting the downloading the DL data to the user terminal 2 (Step S203).

The controller 25 of the user terminal 2 determines whether a permission signal is to be supplied from the data server 1 (Step S102).

In the case where it is determined that the permission signal is not supplied from the data server 1, i.e. that the rejection signal is supplied therefrom (Step S102; NO), the controller 25 terminates the download process.

On the contrary, in the case where it is determined that the permission signal is supplied (Step S102; YES), the controller 25 sends a media ID representing media data including the sample data selected by the user 2A, to the data server 1 (Step S103).

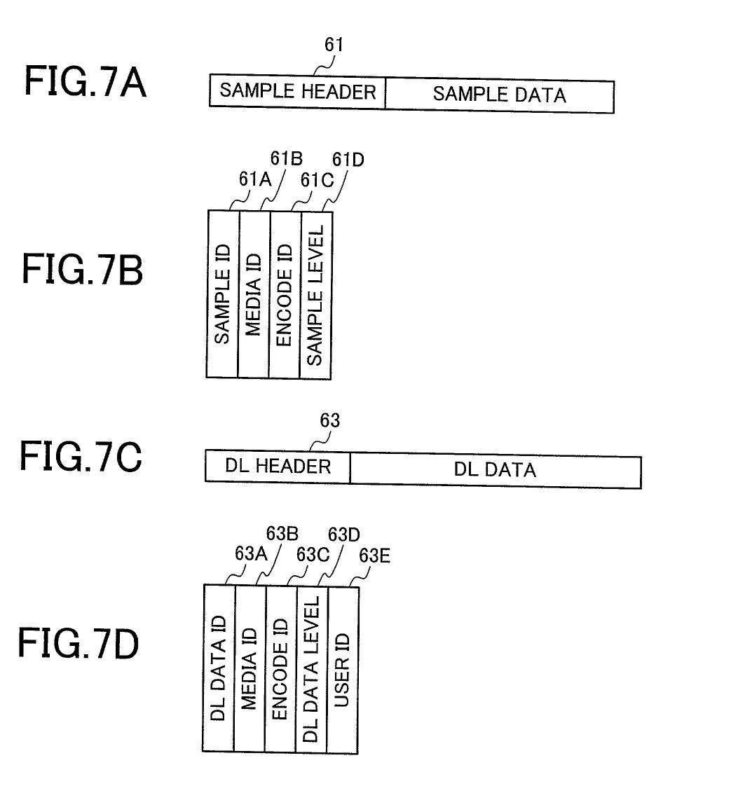

Specifically, a sample header 61 is attached to the head of the sample data, as illustrated in FIG. 7A. The sample header 61 is composed of bits for representing: a sample ID 61A for identifying sample data; a media ID 61B for identifying the media data including the sample data; an encode ID 61C specifying an encryption method and/or compression method of the media data; and a sample level 61D, as shown in FIG. 7B. The controller 25 of the user terminal 2 extracts the media ID 61B from the sample header 61 of the selected sample data, and sends the extracted media ID 61B to the data server 1.

In response to the media ID 61B sent from the user terminal 2, the controller 14 of the data server 1 sends predetermined media information stored in the database 13 to the user terminal 2 (Step S204).

Specifically, a DL header 63 is attached to the head of the DL data, as shown in FIG. 7C. As illustrated in FIG. 7D, the DL header 63 is composed of bits for representing: a DL data ID 63A for identifying the DL data; a media ID 63B for identifying media data including the DL data; an encode ID 63C specifying an encryption method and/or compression method of the media data; a DL data level 63D; and a user ID 63E. The user ID 63E is written when the DL data is downloaded. The controller 14 of the data server 1 determines the DL data including the DL header 63 having the media ID 63B conforming to the supplied media ID 61B. The controller 14 acquires the media information corresponding the determined DL data from the database 13, and sends the acquired information to the user terminal 2.

The controller 25 of the user terminal 2 controls the display unit 23, and provides the user 2A with the contents (the price and data amount of the DL data) of the media information to the supplied from the data server 1. Upon this, the controller 25 determines whether to execute the downloading of the DL data (Step S104).

In particular, the user 2A checks the contents of the media information displayed on the display unit 23 of the user terminal 2, and determines whether to download the DL data. The user 2A operates the operational unit 22 based on his/her determination. The operational unit 22 outputs, to the controller 25, a signal representing whether to download the LD data, in accordance with the operation of the user 2A. The controller 25 determines whether to download the DL data, in accordance with the signal sent from the operational unit 22.

In the case where it is determined that the DL data is not to be downloaded (Step S104; NO), the controller 25 terminates the download process.

In the case where it is determined that the DL data is to be downloaded (Step S104; YES), the controller 25 sends a request signal for requesting the DL data to the data server 1 (Step S105).

In response to the request signal from the user terminal 2, the controller 14 of the data server 1 acquires the user-selected DL data from the database 13, and sends the acquired data to the user terminal 2 (Step S205). At this time, the controller 14 writes the user ID 63E in the DL header 63, as information for identifying the receiver of the DL data.

Upon normal completion of the downloading of the DL data, the controller 25 of the user terminal 2 sends a download-completion signal representing that the DL data has completely been downloaded to the data server 1 (Step S106).

In response to the download-completion signal, the controller 14 of the data server 1 sends a predetermined media key to the user terminal 2 (Step S206).

Upon reception of the media key from the data server 1, the controller 25 of the user terminal 2 sends a key-reception signal representing that the media key has been received to the data server 1 (Step S107), and the download process is completed.

In response to the key-reception signal sent from the user terminal 2, the controller 14 of the data server 1 carries out a charge process (Step S207). Specifically, the controller 14 updates the charge data of the user 2A which is stored in the database 13, and completes the data supply process.

The payment is made based on the charge data, every time the DL data is downloaded or on a predetermined date of each month, using a credit card or the like, for example.

After the desired DL data is downloaded as described above, the user 2A operates the operational unit 22 of the user terminal 2, and instructs the user terminal 2 to generate reproduction data to be reproduced.

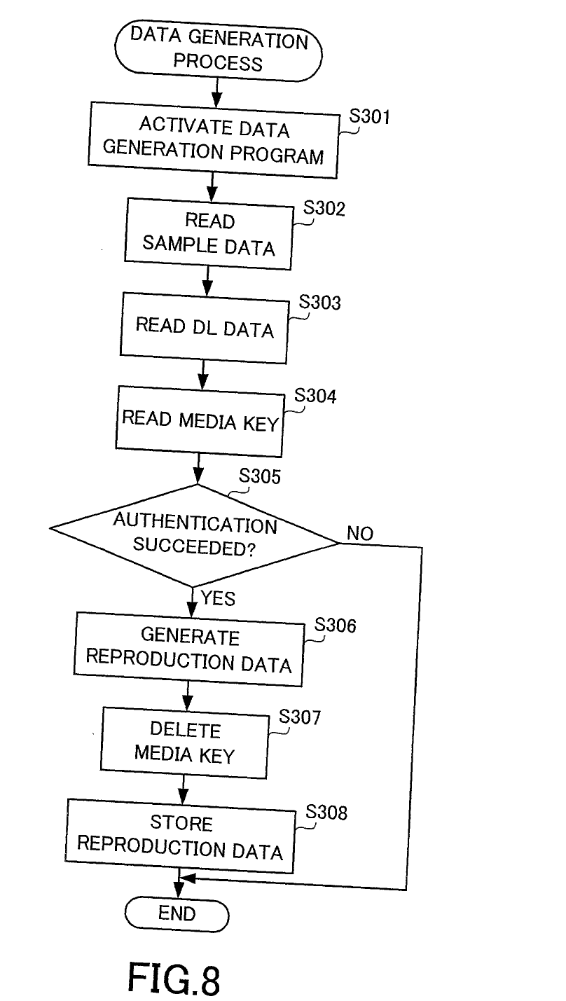

In response to the instruction of the user 2A, the controller 25 of the user terminal 2 begins to carry out a data generation process shown in FIG. 8.

The controller 25 activates the data generation program stored in the memory unit 24 (Step S301). The controller 25 generates the reproduction data, in accordance with this data generation program.

The controller 25 reads out the sample data which is selected by the user 2A (Step S302).

Subsequently, the controller 25 reads out the DL data which has been downloaded from the data server 1 (Step S303).

The controller 25 reads out the media key which has been supplied from the data server 1 (Step S304).

After this, the controller 25 carries out an authentication process for authenticating the supplied media key (Step S305). For example, when issuing the media key, the controller 14 of the data server 1 attaches the user ID to the media key, as information for identifying the user 2A to be supplied with the media key. The controller 25 of the user terminal 2 determines whether the user ID stored in the memory unit 24 coincides with the user ID attached to the media key, so as to authenticate the media key. Hence, the controller 25 can determine whether the supplied media key is a proper media key.

In the case where the authentication is not succeeded (Step S305; NO), the controller 25 terminates the data generation process.

In the case where the authentication is succeeded (Step S305; YES), the controller 25 generates the reproduction data from the sample data and DL data, using the media key (Step S306).

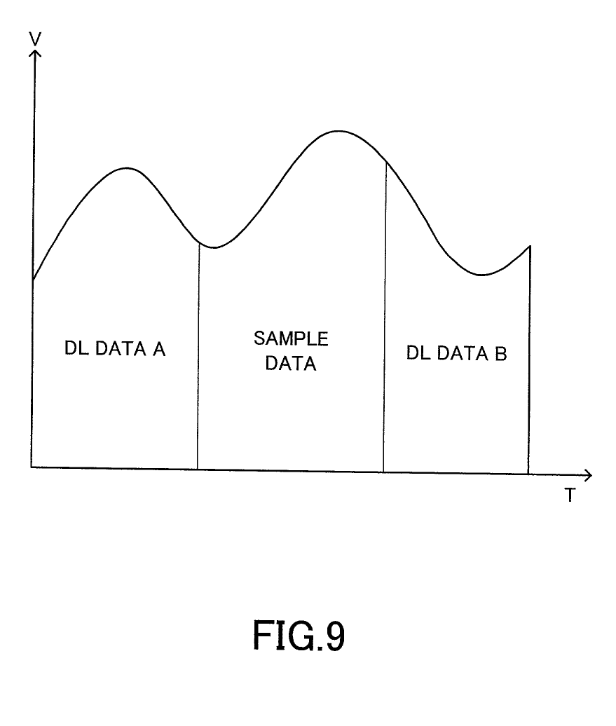

Specifically, the controller 25 divides the DL data into the DL data A and DL data B, based on information specified by the media key. The controller 25 sets the sample data, DL data A and DL data B in time series, as shown in FIG. 9, and thus generating the media data. The controller 25 encrypts and/or compresses the media data, in accordance with a method specified by the encode ID 61C included in the sample header 61 of the sample data or a method specified by the encode ID 63C included in the DL header 63 of the DL data. For example, the controller 25 encrypts and/or compresses the media data, in the form of MP3 (MPEG-1 Audio Layer 3) or Twin VQ (Transform-domain Weighted Interleave Vector Quantization), etc., thereby generating the reproduction data.

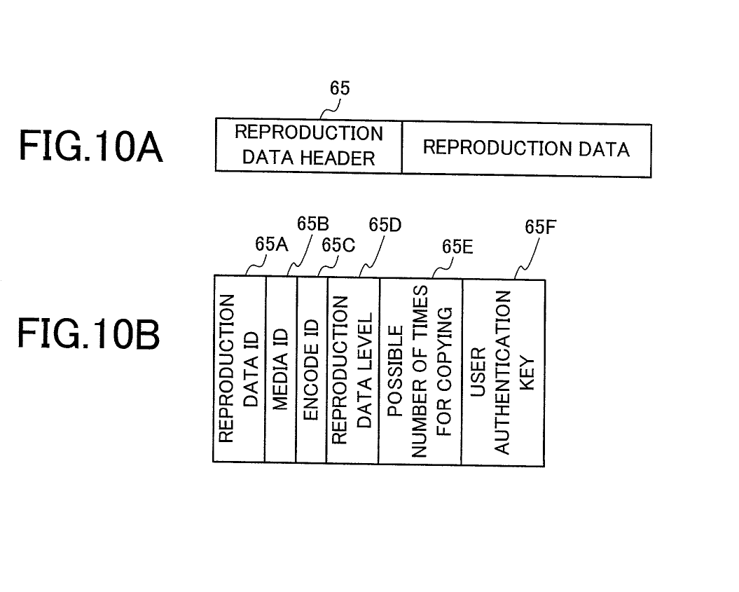

A reproduction data header 65 is attached to the head of the generated reproduction data by the controller 25, as shown in FIG. 10A. The reproduction data header 65 is composed of bits for representing a reproduction data ID 65A, a media ID 65B, an encode ID 65C, a reproduction data level 65D, a possible number of times for copying 65E, and a user authentication key 65F, etc. The possible number of times for copying 65E represents the possible number of times the reproduction data can be copied, while the user authentication key 65F is an ID for authenticating the user 2A having purchased the reproduction data. With the utilization of the possible number of times for copying 65E and the user authentication key 65F, the reproduction data is prevented from being illegally copied, and the copyright of the media data is protected.

After this, the controller 25 deletes the media key stored in the memory unit 24 to prevent the media data from being illegally generated (Step S307). For example, the controller 25 controls the memory unit 24, and writes predetermined data over an area where the media key has been stored, thereby deleting the media key.

The controller 25 stores the generated reproduction data in the memory unit 24 (Step S308), thereby completing the data generation process.

The user 2A operates the operational unit 22 of the user terminal 2, and reproduces the generated reproduction data.

Specifically, in response to a predetermined signal sent from the operational unit 22 by the operation of the user 2A, the controller 25 of the user terminal 2 executes the player (reproduction program) stored in the memory unit 24. At this time, the controller 25 may authenticate the user 2A, using the user authentication key 64F of the reproduction data header 65.

The controller 25 determines a decoding method and/or uncompression method for the reproduction data, based on information specified by the encode ID 65C of the reproduction data header 65.

The controller 25 decodes and/or uncompresses the reproduction data using the determined method, and reproduces the reproduction data.

Thus reproduced data is displayed on the display unit 23 of the user terminal 2, or output in the form of audio data through a predetermined speaker, etc.

Accordingly, the DL data created by excluding the sample data from the media data is downloaded, thereby achieving the downloading of the DL data in a short period of time, because the same data is not repeatedly downloaded to the user terminal 2. Since the same data is not downloaded twice, the amount of data to be transmitted can be reduced, and it is not really necessary to compress the DL data at the time of downloading. Because the DL data is not compressed, the audio data is unlikely to be deteriorated at the time the audio data is reproduced. Note that the charge process is executed upon completion of the downloading. Hence, the user 2A can certainly acquire desired media data. Because the charge process is not to be repeated, the media data can be downloaded with high efficiency.

It is not necessary that the player (the reproduction program) is installed in the user 2 in advance. In this case, the controller 14 of the data server 1 may inform the user 2A, utilizing the data server 1 at the first time, that a predetermined reproduction program is necessary for reproducing the data. After this, the controller 14 may supply the user terminal 2 with a reproduction program.

The user 2A may purchase a recording medium (CD-ROM, etc.) recording the sample data, data generation program, and/or player, from the data distributor 1A or sample provider 3A, and install the purchased data in the user terminal 2.

It is not limited that the sample data corresponds to the development part of a song, and may correspond to the introduction part of the song. Further, in the case of video data distribution, a peculiar part of video data which would the highlight of a set of video data may be distributed as sample data.

The data distributor 1A and sample provider 3A may be the same.

It is not necessary to prepare a dedicate system to realize the distribution system of the present invention, and the present invention can be realized using a general-purpose computer. For example, the programs and data for controlling a computer to execute the above processes may be recorded and distributed in the form of a recording medium (such as an FD, CD-ROM, DVD, etc.). The programs and data are installed in the computer, and executed on the OS (Operating System), so as to realize the data distribution system of the present invention. The above programs and data may be stored in a disk device, etc., included in a particular server device connected onto the Internet, and embedded in a carrier wave, for example, so as to be downloaded into a computer.

Various embodiments and changes may be made thereonto without departing from the broad spirit and scope of the invention. The above-described embodiment is intended to illustrate the present invention, not to limit the scope of the present invention. he scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2000-280151 filed on Sep. 11, 2000, and including specification, claims, drawings and summary. The disclosure of the above Japanese Patent Application is incorporated herein by reference in its entirety.

What is claimed is:

1. A data distribution system, comprising:
a server which stores, as distribution data to be distributed, media data excluding a data portion which is same as sample data being a part of the media data; and
at least one reproduction terminal which reproduces the media data, and
wherein said reproduction terminal includes
a memory which stores the sample data,
a downloader which downloads predetermined distribution data from said server, and
a player which reproduces the sample data stored in said memory and the distribution data downloaded by said downloader.

2. The data distribution system according to claim 1, wherein said player includes a data generator which generates the media data from predetermined sample data stored in said memory and the distribution data downloaded by said downloader.

3. The data distribution system according to claim 2, wherein said data generator:
divides the distribution data into a part corresponding to a data portion preceding the sample data in the media data and a part corresponding to a data portion following the sample data in the media data; and
arranges the divided distribution data and sample data in time series, thereby generating the media data.

4. The data distribution system according to claim 3, wherein:
said data generator encodes the generated media data using a predetermined encoding method; and
said player decodes the encoded media data using a predetermined decoding method, and reproduces the decoded media data.

5. The data distribution system according to claim 4, wherein:
said data generator attaches a header including information regarding the predetermined encoding method for encoding the media data, to the encoded media data; and
said player decodes the encoded media data, based on the information included in the header.

6. The data distribution system according to claim 3, wherein:
said server includes a supplier which supplies said at least one reproduction terminal having downloaded the distribution data with a media key representing information for dividing the distribution data; and
said data generator divides the distribution data using the supplied media key.

7. The data distribution system according to claim 6, wherein said data generator determines whether the media key supplied from said server is a proper media key, and generates the media data using the media key, in a case where it is determined that the media key is a proper media key.

8. The data distribution system according to claim 7, wherein said data generator deletes the media key, in a case where the media data is completely generated.

9. The data distribution system according to claim 1, wherein said server includes a charger which charges, in a case where said at least one reproduction terminal completely downloads the distribution data, a user operating said at least one terminal for the distribution data.

10. A data distribution method comprising:
storing, as distribution data to be distributed, media data excluding a data portion which is same as sample data being a part of the media data, in a server;
storing the sample data being the part of the media data in at least one terminal;
downloading predetermined distribution data from said server into said at least one terminal through a communications network; and
reproducing the stored sample data and the downloaded distribution data in said at least one terminal.

11. The data distribution method according to claim 10, wherein said reproducing includes generating, in said at least one terminal, the media data from the stored sample data and downloaded distribution data.

12. The data distribution method according to claim 11, wherein said generating includes:
dividing the distribution data into a part corresponding to a data portion preceding the sample data in the media data and a part corresponding to a data portion following the sample data in the media data; and
arranging the divided distribution data and the sample data in time series, thereby generating the media data.

13. The data distribution method according to claim 12, wherein:
said generating includes encoding the generated media data using a predetermined encoding method; and
said reproducing includes decoding the encoded media data using a predetermined decoding method and reproducing the decoded media data.

14. The data distribution method according to claim 13, wherein:
said encoding includes attaching a header including information regarding the encoding method for encoding the media data, to the encoded media data; and
said reproducing includes decoding the encoded media data, based on the information included in the header.

15. The data distribution method according to claim 12, further including
supplying, from said server, a media key representing information for dividing the distribution data to said at least one terminal having downloaded the distribution data, and
wherein said dividing includes dividing the distribution data using the media key.

16. The data distribution method according to claim 15, wherein:
said generating includes determining whether the media key is a proper media key; and
said dividing includes dividing the distribution data using the media key in a case where it is determined that the media key is a proper media key.

17. The data distribution method according to claim 16, wherein said generating includes deleting the media key, in a case where the media data is completely generated.

18. The data distribution method according to claim 10, further including
charging, in a case where said at least one terminal has completely downloaded the distribution data, a user operating said at least one terminal for the downloaded distribution data, in said server.

19. A data distribution device, comprising:
a memory which stores, as distribution data to be distributed, media data excluding a data portion which is same as sample data being a part of the media data; and
a data supplier which supplies at least one terminal with predetermined distribution data stored in said memory through a communications network, in response to a request from said at least one terminal storing the sample data.

20. The data distribution device according to claim 19, further including a charger which charges, in response to a completion signal being sent from said at least one terminal and representing that the distribution data is completely received, a user operating said at least one terminal, for the supplied distribution data.

21. The data distribution device according to claim 19, further including an information supplier which supplies a media key representing information for dividing the distribution data into a part corresponding to a data portion preceding the sample data in the media data and a part corresponding to a data portion following the sample data in the media data, to said at least one terminal having received the distribution data.

22. A data reproduction device comprising:
a memory which stores sample data being a part of media data;
a downloader which downloads distribution data to be distributed from a server storing, as the distribution data, the media data excluding a data portion which is same as the sample data, through a communications network; and
a player which reproduces the sample data stored in said memory and the distribution data downloaded by said downloader.

23. The data reproduction device according to claim 22, wherein said player includes a data generator which generates the media data from predetermined sample data stored in said memory and the distribution data downloaded by said downloader.

24. The data reproduction device according to claim 23, wherein said data generator:
divides the distribution data into a part corresponding to a data portion preceding the sample data in the media data and a part corresponding to a data portion following the sample data in the media data; and
arranges the divided distribution data and sample data in time series, thereby generating the media data.

25. The data reproduction device according to claim 24, wherein:
said data generator encodes the generated media data using a predetermined encoding method; and
said player decodes the encoded media data using a predetermined decoding method and reproduces the decoded media data.

26. The data reproduction device according to claim 25, wherein:
said data generator attaches a header including information representing the encoding method for encoding the media data, to the encoded media data; and
said player decodes the encoded media data, based on the information included in the header.

27. The data reproduction device according to claim 24, wherein
said data generator divides the distribution data, using a media key supplied from said server and representing information for dividing the distribution data, and deletes the media key in a case where the media data is completely generated.

28. The data reproduction device according to claim 27, wherein
said data generator determines whether the media key supplied from said server is a proper media key, and generates the media data using the media key, in a case where it is determined that the media key is a proper media key.

29. A program for controlling a computer to function as a data distribution device comprising:
a memory which stores, as distribution data to be distributed, media data excluding a data portion which is same as sample data being a part of the media data; and
a supplier which supplies, in response to a request from a predetermined terminal connected to said computer through a communications network, said terminal with predetermined distribution data stored in said memory.

30. A program for controlling a computer to function as a data distribution device comprising:
a memory which stores sample data being a part of media data;
a downloader which downloads predetermined distribution data to be distributed from a server storing, as the distribution data, the media data excluding a data portion which is same as the sample data being a part of the media data; and
a player which reproduces the sample data stored in said memory and the distribution data downloaded by said downloader.
